(19) United States
(12) Patent Application Publication
(10) Pub. No.: US 2024/0367901 A1
(43) Pub. Date: Nov. 7, 2024

(54) ARTICLE MANAGEMENT SYSTEM, ARTICLE MANAGEMENT METHOD AND NON-TRANSITORY COMPUTER-READABLE MEDIUM

(71) Applicant: NEC CORPORATION, Minato-ku, Tokyo (JP)

(72) Inventors: Jun UCHIMURA, Tokyo (JP); Hiroki Sugegaya, Tokyo (JP); Yasuyo Kazo, Tokyo (JP); Shingo Suzuki, Kanagawa (JP); Akl Nakao, Kanagawa (JP)

(73) Assignee: NEC CORPORATION, Minato-ku, Tokyo (JP)

(21) Appl. No.: 18/684,961

(22) PCT Filed: Aug. 30, 2021
(86) PCT No.: PCT/JP2021/031741

§ 371 Date: Feb. 20, 2024

(51) Int. Cl. B65G 1/04; G06Q 10/047

(52) U.S. Cl. CPC B65G 1/0485; G06Q 10/047

(57) ABSTRACT

An article management system (1) performs at least one of delivery of an article to a customer and receipt of an article from a customer. The article management system (1) includes a first article transportation path (12) that can be used as a first storage location for storing a plurality of articles and can deliver or receive an article with a location (a customer's window) for delivering an article or receiving an article, and a second article transportation path (14) that can be used as a second storage location for storing a plurality of articles and can deliver or receive an article with the first article transportation path (12).

10 Further, the article management system (1) includes a control apparatus (10) that controls operation of the first article transportation path (12) and the second article transportation path (14).

### TECHNICAL FIELD

The present invention relates to an article management system and an article management method.

### BACKGROUND ART

A logistics operation plays a crucial role in supporting persons' lives. With an increase in demand for electronic commerce (EC) in recent years, a volume of logistics-related operation has been increased.

One example of a technique for assisting a logistics operation is disclosed in Patent Document 1 described below, for example. Patent Document 1 described below discloses a package management system that reduces a labor in package receipt operation in a business operator in which an operation of receiving a package is performed. The package management system includes a window apparatus including an automatic receiving function of automatically performing receipt and storing in a warehouse, and an automatic discharging function of automatically discharging a package to be discharged from the warehouse.

### RELATED DOCUMENT

### Patent Document

Patent Document 1: Japanese Patent Application Publication No. 2020-196602

### SUMMARY OF INVENTION

### Technical Problem

In order to deal with an increase of a volume of logistics-related operation, it is required to increase the number of workers involved in the operation, but not all business operators can secure a necessary number of workers due to a limited pool of workers who can be actually secured. In such a case, there is a concern that a workload for each worker is increased. In the logistics operation, there is a desire for a technique for reducing the number of workers and labor.

The present invention has been made in view of the above-mentioned problem. One of objects of the present invention is to provide a technique for reducing the number of workers and labor in a logistics operation.

### Solution to Problem

According to the present disclosure, there is provided an article management system for performing at least one of delivery of an article to a customer and receipt of an article from a customer, the article management system including:
a first article transportation path that can be used as a first storage location for storing a plurality of articles, and can deliver or receive an article with a location for delivering an article or receiving an article;
a second article transportation path that can be used as a second storage location for storing a plurality of articles, and can deliver or receive an article with the first article transportation path; and
a control unit that controls the first article transportation path and the second article transportation path.

An article management method according to the present disclosure includes,
by a computer, managing an article by controlling
a first article transportation path that can be used as a first storage location for storing a plurality of articles, and can deliver or receive an article with a location for delivering an article or receiving an article, and
a second article transportation path that can be used as a second storage location for storing a plurality of articles, and can deliver or receive an article with the first article transportation path.

The present disclosure includes a program causing a computer to function as
a control unit that controls a first article transportation path that can be used as a first storage location for storing a plurality of articles and can deliver or receive an article with a location for delivering an article or receiving an article, and a second article transportation path that can be used as a second storage location for storing a plurality of articles and can deliver or receive an article with the first article transportation path.

### Advantageous Effects of Invention

According to the present invention, it is possible to reduce the number of workers and labor in a logistics operation.

### BRIEF DESCRIPTION OF DRAWINGS

FIG. 1 It is a diagram schematically illustrating a function configuration example of an article management system according to a first example embodiment.

FIG. 2 It is a diagram illustrating a configuration example of a first article transportation path.

FIG. 3 It is a diagram illustrating a first configuration example of a second article transportation path.

FIG. 4 It is a diagram illustrating a second configuration example of the second article transportation path.

FIG. 5 It is a block diagram illustrating a hardware configuration of a control apparatus.

FIG. 6 It is a flowchart illustrating a flow of processing of receiving an article from a customer.

FIG. 7 It is a diagram illustrating one example of information indicating a usage state of the second article transportation path.

FIG. 8 It is a diagram illustrating a correlation between a section ID and each of sections of the second article transportation path.

FIG. 9 It is a diagram illustrating a flow of processing when an article is delivered to a customer.

FIG. 10 It is a diagram illustrating one example of information indicating a position relationship of each of the sections of the second article transportation path.

FIG. 11 It is a diagram illustrating one example of information indicating a usage state of each of the sections of the second article transportation path.

FIG. 12 It is a diagram illustrating a control operation being performed for the first article transportation path and the second article transportation path by the control apparatus.

FIG. 13 It is a diagram illustrating the control operation being performed for the first article transportation path and the second article transportation path by the control apparatus.

FIG. 14 It is a diagram illustrating the control operation being performed for the first article transportation path and the second article transportation path by the control apparatus.

FIG. 15 It is a diagram illustrating the control operation being performed for the first article transportation path and the second article transportation path by the control apparatus.

FIG. 16 It is a diagram schematically illustrating a function configuration example of an article management system according to a second example embodiment.

FIG. 17 It is a diagram illustrating an arrangement example of a first article transportation path, a second article transportation path, and a third article transportation path in the article management system according to the second example embodiment.

FIG. 18 It is a flowchart illustrating a flow of processing performed by a control apparatus according to the second example embodiment.

### DESCRIPTION OF EMBODIMENTS

Example embodiments of the present invention are described below with reference to the drawings. Note that, in all the drawings, a similar constituent element is denoted with a similar reference sign, and description therefor will not be repeated as appropriate. Further, unless otherwise particularly described, each block in each of the block diagrams represents a configuration in a function unit instead of a configuration in a hardware unit. Further, when there is provided an arrow in the drawings, a direction of the arrow is merely for better understanding of a flow of information. The direction of the arrow in the drawings does not limit a direction of communication (unidirectional communication/bidirectional communication), unless otherwise particularly described.

An article management system 1 according to the present disclosure is used in a logistics center for storing and distributing an article. In the following example embodiments, basically, the article management system 1 is described while assuming a case of use in a logistics center. Note that, the article management system 1 according to the present disclosure is applicable not only in the logistics center but also in a field where operations such as transportation and picking of an article are performed. For example, the article management system 1 according to the present disclosure may be used similarly in a supermarket, a shopping mall, a library, a rental shop, or the like.

### First Example Embodiment

### Function Configuration Example

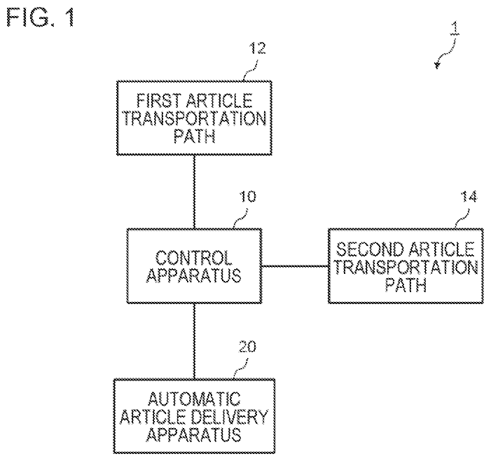

FIG. 1 is a diagram schematically illustrating a function configuration example of an article management system 1 according to a first example embodiment. As illustrated in FIG. 1, the article management system 1 is configured to include a control apparatus 10, a first article transportation path 12, and a second article transportation path 14.

Further, in the example of the present drawing, the article management system 1 is configured to include an automatic article delivery apparatus 20. The automatic article delivery apparatus 20 is an apparatus that automatically performs at least one of delivery of an article to a customer and receipt of an article from a customer in conjunction with the function units of the article management system 1 described above. For example, the automatic article delivery apparatus 20 may be configured as an apparatus being similar to a window apparatus in Patent Document 1 described below.

The first article transportation path 12 is an apparatus that automatically transports an article, for example, such as a belt conveyer and a roller conveyer.

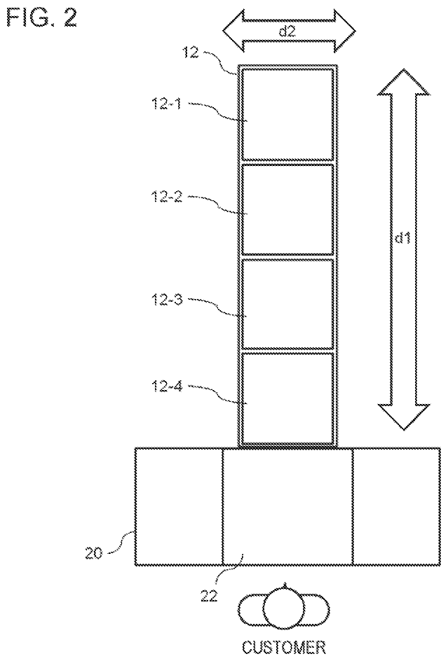

FIG. 2 is a diagram illustrating a configuration example of the first article transportation path 12. As illustrated in FIG. 2, the first article transportation path 12 is connected to the automatic article delivery apparatus 20, specifically, to a customer's window 22 (a location for performing delivery of an article or receipt of an article) of the automatic article delivery apparatus 20. Further, the first article transportation path 12 is configured to include N sections (N is an integer equal to or greater than two). The “section” referred herein indicates a region allocated to each article to be transported. In the example in FIG. 2, the first article transportation path 12 includes four sections (12-1, 12-2, 12-3, and 12-4), and four articles at maximum can be placed thereon at the same time. Although details thereof are described later, the sections 12-1 to 12-4 may also be used as storage locations for storing articles (hereinafter, also referred to as “first storage locations”). Each of the sections 12-1 to 12-4 includes a mechanism that moves an article in a front-and-rear direction (an extension direction of a transportation path, a d1 direction in the drawing) and a mechanism that moves an article in a right-and-left direction (a direction orthogonal to the extension direction of the transportation path, a d2 direction in the drawing) in each of the sections of the transportation path. The control apparatus 10 is capable of moving, to the customer's window, an article to be delivered to a customer who is in front of the automatic article delivery apparatus 20 and collecting an article being put into the customer's window of the automatic article delivery apparatus 20 by a customer, by controlling the mechanisms of each of the sections of the first article transportation path 12.

Note that, structure of the first article transportation path 12 illustrated in FIG. 2 is merely one example. The structure of the first article transportation path 12 may be decided as appropriate according to an area of a location into which the article management system 1 is introduced.

Similarly to the first article transportation path 12, for example, the second article transportation path 14 is an apparatus that automatically transports an article, for example, such as a belt conveyer and a roller conveyer.

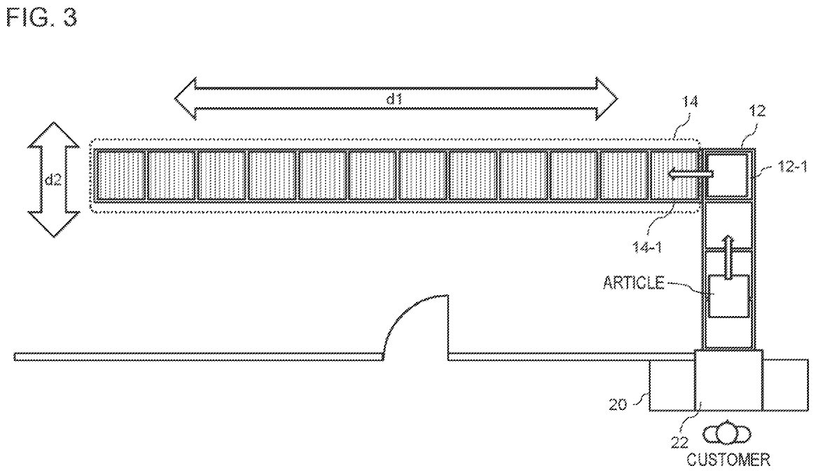

FIG. 3 is a diagram illustrating a first configuration example of the second article transportation path 14. In the example in FIG. 3, the second article transportation path 14 includes 12 sections (sections indicated with vertical lines), and 12 articles at maximum can be placed thereon at the same time. Similarly to the first article transportation path 12, the sections may be used as storage locations for storing articles (hereinafter, also referred to as “second storage locations”). In the example in FIG. 3, the second article transportation path 14 also functions as a storage location for temporarily storing an article received from a customer. Each of the sections of the second article transportation path 14 includes at least a mechanism that moves an article in the front-and-rear direction (the extension direction of the transportation path, a d1 direction in the drawing). Similarly to the first article transportation path 12, each of the sections of the second article transportation path 14 may further include a mechanism that moves an article in the right-and-left direction (the direction orthogonal to the extension direction of the transportation path, a d2 direction in the drawing) in each of the sections of the transportation path.

In the example of FIG. 3, an article is moved to each of the sections of the second article transportation path 14 in the following manner, for example. First, the control apparatus 10 controls the mechanism of each of the sections of the first article transportation path 12, and then moves an article, which is collected from the automatic article delivery apparatus 20, along the extension direction of the first article transportation path 12 to the section 12-1 located at the very end. After that, the control apparatus 10 changes a moving direction of the article by controlling the mechanism of the section 12-1, and moves the article to a section 14-1 of the second article transportation path 14. Then, the control apparatus 10 controls the mechanism of each of the sections of the second article transportation path 14, and moves the article in an orderly manner from the left most section without a space. Such processing is repeated, and thus an article is placed and stored in each of the sections of the second article transportation path 14 illustrated in FIG. 3.

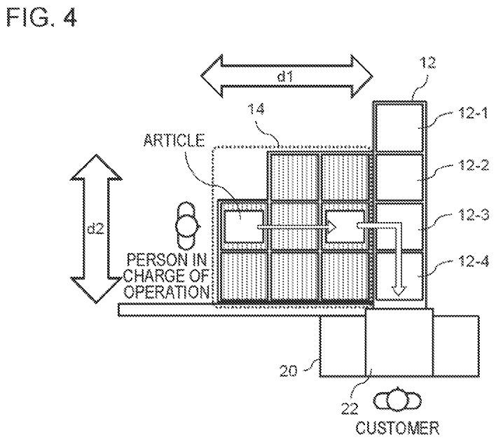

FIG. 4 is a diagram illustrating a second configuration example of the second article transportation path 14. In the example in FIG. 4, the second article transportation path 14 includes eight sections (sections indicated with the vertical lines), and eight articles at maximum can be placed thereon at the same time. Similarly to the first article transportation path 12, the sections may be used as storage locations for storing articles (second storage locations). In the example in FIG. 4, the second article transportation path 14 also functions as a storage location for temporarily storing an article to be delivered to a customer. Each of the sections of the second article transportation path 14 includes at least a mechanism that moves an article in the front-and-rear direction (the extension direction of the transportation path, a d1 direction in the drawing). Similarly to the first article transportation path 12, each of the sections of the second article transportation path 14 may further include a mechanism that moves an article in the right-and-left direction (the direction orthogonal to the extension direction of the transportation path, a d2 direction in the drawing) in each of the sections of the transportation path.

In the example in FIG. 4, an article is moved to each of the sections of the second article transportation path 14 in the following manner, for example. First, a person in charge of the operation carries an article to be discharged from the automatic article delivery apparatus 20, and places the article in any one of the sections being located on the frontmost side of the sections of the second article transportation path 14. The control apparatus 10 controls the mechanism of each of the sections of the second article transportation path 14, and moves the article along a line of the section on which the article is placed, in an orderly manner from the section located on the rightmost side without a space. Such processing is repeated, and thus an article is placed and stored in each of the sections of the second article transportation path 14 illustrated in FIG. 4. After that, when a customer inputs information relating to an article that the customer wishes to receive in the automatic article delivery apparatus 20, the control apparatus 10 controls the mechanisms of each of the first article transportation path 12 and the second article transportation path 14, and thus moves the article associated with the input information, to the customer's window 22. With this, a customer can receive a desired article.

According to the present example embodiment, at least a part of the logistics operation such as receipt of an article from a customer, delivery of an article to a customer, and transportation of an article can be automated. With this, an effect of reducing the number of workers involved in a logistics operation and reducing labor in management operation for articles can be expected.

Herein, when the second article transportation path 14 functions as a storage location for temporarily storing an article to be delivered to a customer, the second article transportation path 14 is configured to allow an article to be placed in any section of a plurality of sections (regions) provided to the first article transportation path 12. This configuration is a key in specific processing of delivering an article to a customer, which is described later in detail. For example in the example in FIG. 4, the second article transportation path 14 includes a plurality of lines (conveyers). Each of the plurality of lines of the first article transportation path 12 are connected to different sections of the first article transportation path 12. Further, the number of articles that can be stored in each of the lines (in other words, the number of sections provided to each of the lines) is decided based on a position of the section of the first article transportation path 12 to which the line is connected. For example, in the example in FIG. 4, three lines are present in the d1 direction, and the number of sections provided to the lines are two, three, and three in the stated order from the top. The number of the section provided to each of the lines is decided based on the number of relocation spaces that can be secured in the first article transportation path 12. For example, the line located on the uppermost side in the drawing is connected to the section 12-2 of the first article transportation path 12. When a moving route from a section on the line to the automatic article delivery apparatus 20 is examined, only one section (the section 12-1) can be secured as a relocation space in the first article transportation path 12. Thus, in the line on the uppermost side, two sections at maximum can be provided in consideration of the number of articles that can be relocated. Similarly, in the line in the middle of the drawing, two sections (the section 12-1, the section 12-2) can be secured as relocation spaces, and hence three sections at maximum can be provided. Further, in the line on the lowermost side in the drawing, three sections (the section 12-1, the section 12-2, the section 12-3) can be secured as relocation spaces, and hence four sections at maximum can be provided theoretically.

Note that, when each of the sections of the second article transportation path 14 includes the mechanism that moves an article in the front-and-rear direction and the mechanism that moves an article in the right-and-left direction, an article can be moved to any section in the second article transportation path 14 by combining control in the front-and-rear direction and the right-and-left direction in each of the sections. In this case, when there is at least one section, which can be secured as the relocation space, in any of the first article transportation path 12 and the second article transportation path 14, the control apparatus 10 is capable of moving an article to any section (position) in a manner of a sliding puzzle by controlling the mechanism of each of the sections of the first article transportation path 12 and the second article transportation path 14. Further, when an article can be moved to a section of the second article transportation path 14 being adjacent to any section of the first article transportation path 12, the article can be placed on any section of the first article transportation path 12. In this case, limitation of the number of sections based on the position as described above is not imposed on the second article transportation path 14.

When the second article transportation path 14 is used as a route for transporting an article to be delivered to a customer, a larger space is originally required for securing a moving route of an article from each of the sections. In the article management system 1 according to the present disclosure, the control apparatus 10 performs the above-mentioned control, and thus a moving route of an article from each of the sections can be created. With this, limitation in introducing the article management system 1 according to the present disclosure (limitation of an installation space) is alleviated, and a larger number of business operators can enjoy an effect of reducing the number of workers and labor in a logistics operation.

Note that, structure of the second article transportation path 14 that is illustrated in FIGS. 3 and 4 is merely examples. The structure of the second article transportation path 14 may be decided as appropriate according to an area of a location into which the article management system 1 is introduced. Further, the second article transportation path 14 may be configured in a three-dimensional manner by arraying planar (two-dimensional) structures as illustrated in FIGS. 3 and 4 in a height direction. In this case, in any one of the sections, the second article transportation path 14 includes an elevating machine capable of moving in the height direction. By structuring the second article transportation path 14 in the three-dimensional manner, a larger number of articles can be managed within the same land area.

### Hardware Configuration of Control Apparatus 10

Each of functional constituent units of the control apparatus 10 may be achieved by hardware (example: a hard-wired electronic circuit), or may be achieved by a combination of hardware and software (example: a combination of an electronic circuit and a program for controlling the same). Description is further made below on a case in which each of the functional constituent units of the control apparatus 10 is achieved by a combination of hardware and software.

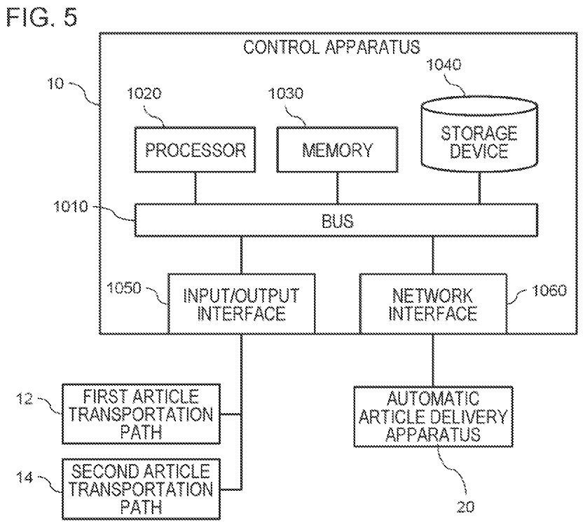

FIG. 5 is a block diagram illustrating a hardware configuration of the control apparatus 10. The control apparatus 10 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each of the functions of the control apparatus 10 described in the present specification. The processor 1020 reads the program module on the memory 1030 and executes the program module, and thereby each of the functions of the control apparatus 10 described in the present specification is achieved.

The input/output interface 1050 is an interface for connecting the control apparatus 10 to a peripheral device. In one example, the control apparatus 10 is capable of transmitting a control signal to the first article transportation path 12 and the second article transportation path 14 via the input/output interface 1050.

The network interface 1060 is an interface for connecting the control apparatus 10 to another apparatus on a network. For example, the network is a local area network (LAN) or a wide area network (WAN). Wireless connection or wired connection may be adopted as a method by which the network interface 1060 is connected to the network. In one example, the control apparatus 10 is connected to the automatic article delivery apparatus 20 in a communicable manner via the network interface 1060.

Note that, the hardware configuration illustrated in FIG. 5 is merely one example. The hardware configuration of the control apparatus 10 according to the present disclosure is not limited to the example in FIG. 5. For example, in the example in FIG. 5, the control apparatus 10 and the automatic article delivery apparatus 20 are illustrated as separate apparatuses, but the automatic article delivery apparatus 20 may also include the functions of the control apparatus 10.

### Flow of Processing

Description is made below on one example of processing being performed by the article management system 1 according to the first example embodiment. In the article management system 1, at least one of (1) processing of receiving an article from a customer and (2) processing of delivering an article to a customer is performed.

### «Processing of Receiving Article From Customer»

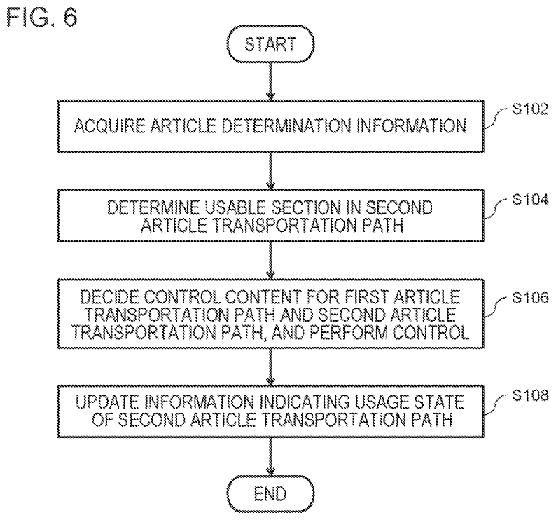

First, for example, the following processing is performed in the automatic article delivery apparatus 20. A customer uses an input apparatus (example: a scanner, a keyboard, and the like) provided to the automatic article delivery apparatus 20, which is omitted in illustration, to input information for identifying an article to be placed in the customer's window 22. When required information is input, a shutter provided to the customer's window 22, which is omitted in illustration, is opened, and an article can be put. After the shutter is opened, a customer puts the article into the customer's window 22. Note that, the automatic article delivery apparatus 20 may be configured to measure a size or a weight of the put article at this timing and accept payment required for a delivery charge for the article. Further, the automatic article delivery apparatus 20 may be configured to receive a delivery option of the article (delivery at a low-temperature state or the like) and perform required processing (processing of notifying a staff member or the like). When the processing of receiving an article from a customer is completed in the automatic article delivery apparatus 20, processing as illustrated in FIG. 6 is performed as processing of the article management system 1 according to the present example embodiment.

FIG. 6 is a flowchart illustrating a flow of the processing of receiving an article from a customer.

First, the control apparatus 10 acquires information (article determination information) for determining an article being put into the customer's window 22 (S102). For example, the article determination information is generated based on information being input via the input apparatus of the automatic article delivery apparatus 20.

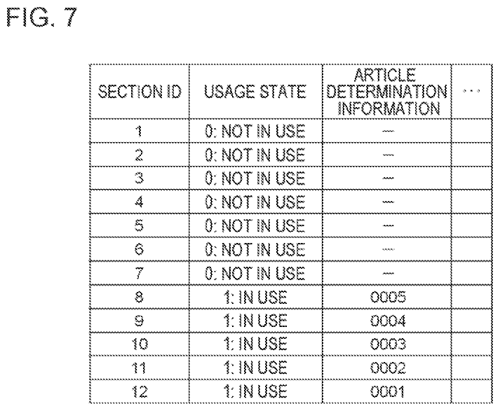

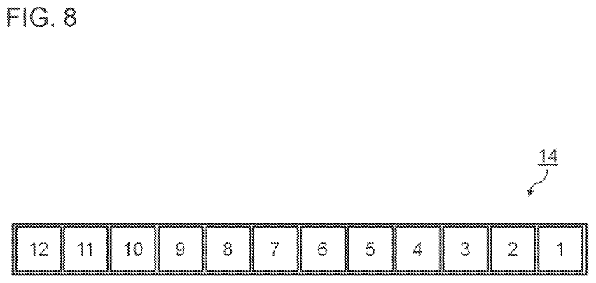

When the article determination information is acquired, the control apparatus 10 determines a usable (available) section in the second article transportation path 14 (S104). For example, for the second article transportation path 14, it is possible to determine a usable section by referring to information indicating a usage state of the second article transportation path 14 being used for storing an article received from a customer, which is as illustrated in FIG. 7. FIG. 7 is a diagram illustrating one example of the information indicating the usage state of the second article transportation path 14. The information illustrated in FIG. 7 includes information (section ID) for identifying each of the sections, information (0: not in use, 1: in use) indicating whether each of the sections is in use, and article determination information indicating an article stored in each of the sections in association with one another. Further, it is assumed that the section ID illustrated in FIG. 7 is allocated as illustrated in FIG. 8. FIG. 8 is a diagram illustrating a correlation between the section ID and each of the sections of the second article transportation path 14. The control apparatus 10 is capable of deciding that the section with the “section ID: 12” to the section with the “section ID: 8” are in use, based on the information illustrated in FIG. 7, and hence the section with the “section ID: 7” can be determined as a section for storing an article received from a customer.

The control apparatus 10 decides a control content performed for the first article transportation path 12 and the second article transportation path 14, and controls the first article transportation path 12 and the second article transportation path 14 according to the control content in order to move an article to the section being determined as a section for storing the article (S106). With this, the article is moved and placed in the section determined in the processing in S104. When the article is moved to the section determined in the processing in S104, the control apparatus 10 updates the information illustrated in FIG. 7 (S108). Specifically, the control apparatus 10 changes a value in a column “usage state” to “1: in use” in a row associated to the section determined in S106, and also stores the article determination information acquired in S102 in the column “article determination information”. With this, the information indicating the usage state of the second article transportation path 14 is updated to the latest state.

Herein, the number of articles that can be stored in the second article transportation path 14 is limited, and hence the article management system 1 preferably includes a mechanism for collecting an article stored in the second article transportation path 14 as appropriate. For example, there may be provided a collection button in a vicinity of an end of the second article transportation path 14 and a mechanism for moving all the articles stored in the second article transportation path 14 to a predetermined position when the button is pressed down. In this case, when a signal generated by pressing down the button is received, the control apparatus 10 controls the second article transportation path 14, and moves an article stored in the second article transportation path 14. Further, when a basket cart or the like is arranged at a predetermined position (for example, a position adjacent to the end of the second article transportation path 14), an article moved along the second article transportation path 14 is automatically loaded in the basket cart. With such a configuration, there can be expected an effect of reducing labor of a person in charge of the operation for loading and transporting an article.

Further, it is also assumed that an article stored in the second article transportation path 14 is picked up and carried to another location by a person in charge of the operation. For example, it is also conceived that, when an article received from a customer is to be delivered at a low-temperature state, a person in charge of the operation moves the article to a warehouse including a refrigeration function in such a way as to store the article in an appropriate temperature zone until arrival of a delivery vehicle. In this case, the section in which the article which has been picked up was stored becomes an available space. The control apparatus 10 may be configured to perform control for automatically fill an available space generated by picking up an article.

### «Processing of Delivering Article to Customer»

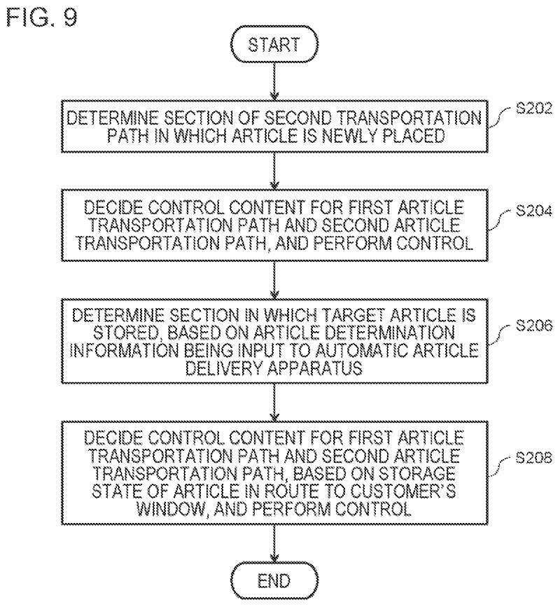

FIG. 9 is a diagram illustrating a flow of processing when an article is delivered to a customer. When an article is delivered to a customer, first, a person in charge of the operation places a target article in the second article transportation path 14 (a storage location for storing an article to be delivered to a customer) as illustrated in FIG. 4. With reference to pre-information such as a desired time for receiving an article, a person in charge of the operation places an article, which is estimated to be picked up by a customer in the near future, in any section of the second article transportation path 14. In this state, the control apparatus 10 determines a section in which a person in charge of the operation newly places an article (S202). For example, the control apparatus 10 may be configured to determine a section in which an article is newly placed, by using a change value being a sensing result from a weight sensor provided to each of the sections. Further, the control apparatus 10 may acquire information indicating a section in which an article is newly placed, via a business terminal used by a person in charge of the operation.

The control apparatus 10 determines the section in which the article is placed, and then decides a control content for the second article transportation path 14 by using information indicating a position relationship of each of the sections of the second article transportation path 14 and information indicating a usage state of each of the sections of the second article transportation path 14 (S204).

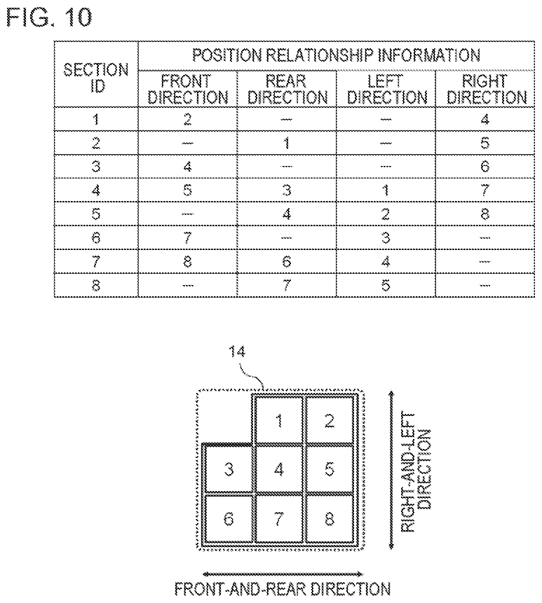

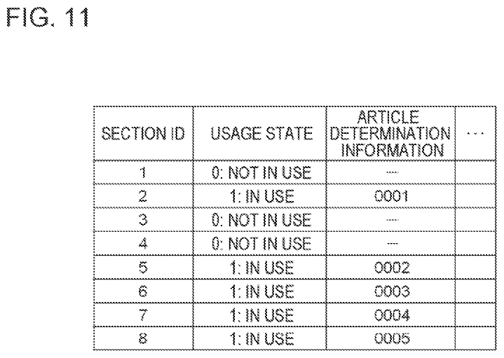

One example of the information indicating the position relationship of each of the sections of the second article transportation path 14 and one example of the information indicating the usage state of each of the sections of the second article transportation path 14 are illustrated in FIG. 10 and FIG. 11, respectively. With reference to the drawings, a specific operation example of the control apparatus 10 is described.

In one example, it is assumed that the section determined in the processing in S202 is the section with the “section ID: 1”. First, the control apparatus 10 determines the section with the “section ID: 2” as the section in front of the section with the “section ID: 1” being determined in the processing in S202, based on the information illustrated in FIG. 10. Then, the control apparatus 10 ascertains a usage state of the section with the “section ID: 2”, based on the information illustrated in FIG. 11. The usage state of the section (the section with the “section ID: 2”) in front of the section with the “section ID: 1” in which the article is newly placed is “1: in use”, and hence the control apparatus 10 decides the section with the “section ID: 2” as the “section to which the article cannot be moved”. As a result, a section to which the article can be moved is not present in front of the section in which the article is newly placed, and hence the control apparatus 10 does not perform control for the second article transportation path 14. In another example, it is assumed that the section determined in the processing in S202 is the section with the “section ID: 3”. First, the control apparatus 10 determines the section with the “section ID: 4” as a section in front of the section with the “section ID: 3” being determined in the processing in S202, based on the information illustrated in FIG. 10. Then, the control apparatus 10 ascertains a usage state of the “section ID: 4”, based on the information illustrated in FIG. 11. The usage state of the section (the section with the “section ID: 4”) in front of the section with the “section ID: 3” in which the article is newly placed is “0: not in use”, and hence the control apparatus 10 decides the section with the “section ID: 4” as the “section to which the article can be moved”. In this case, the control apparatus 10 further determines a section in front of the section determined as the “section to which the article can be moved”, based on the information illustrated in FIG. 10. In this example, the control apparatus 10 further determines the section with the “section ID: 5” as the section in front of the section with the “section ID: 4” being decided as the “section to which the article can be moved”. Then, the control apparatus 10 further ascertains a usage state of the section with the “section ID: 5”, based on the information illustrated in FIG. 11. The usage state of the section with the “section ID: 5” is “1: in use”, and hence the control apparatus 10 decides the section with the “section ID: 5” as the “section to which the article cannot be moved”. Based on those decision results, the control apparatus 10 controls the mechanism of the section with the “section ID: 3”, and performs control for moving the article to the section with the “section ID: 4”.

After that, a customer visits a location in which the article management system 1 is installed (for example, a logistics center). A customer inputs article determination information for determining a target article via the input apparatus (omitted in illustration) of the automatic article delivery apparatus 20. The control apparatus 10 determines a section in which the article to be moved is stored, based on the article determination information being input to the automatic article delivery apparatus 20 (S206). For example, the control apparatus 10 is capable of determining the section in which the article associated with the article determination information being input to the automatic article delivery apparatus 20 is stored, based on the information illustrated in FIG. 11. For example, it is assumed that the article determination information indicating “0003” is input to the automatic article delivery apparatus 20. In this case, the control apparatus 10 may determine the section with the “section ID: 6” as a section in which the target article is stored, based on the information illustrated in FIG. 11.

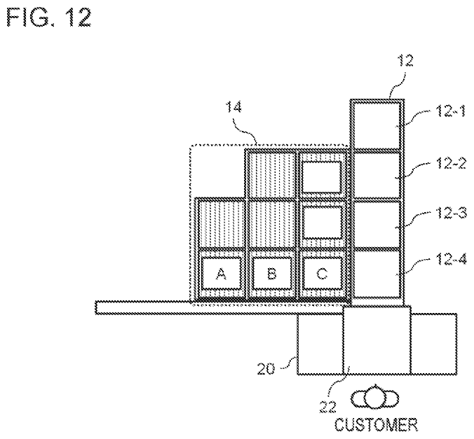

Then, the control apparatus 10 controls the first article transportation path 12 and the second article transportation path 14, based on a storage state of an article along the route from the section being determined to the customer's window of the automatic article delivery apparatus 20 (S208). Specifically, the control apparatus 10 causes the first article transportation path 12 and the second article transportation path 14 to operate in such a way that other articles present along a route from the section in which the target article is stored to the customer's window 22 are temporarily relocated in an available space. The control operation is described with reference to FIGS. 12 to 15. FIGS. 12 to 15 are diagrams illustrating the control operation of the first article transportation path 12 and the second article transportation path 14 performed by the control apparatus 10. In the examples in FIGS. 12 to 15, there is illustrated a control content performed by the control apparatus 10 in a case in which the section with the “section ID: 6” is determined in the processing in S206.

As illustrated in FIG. 12, an article A as an article to be moved is stored in the section with the “section ID: 6”. In a route from the section with the “section ID: 6” to the customer's window 22, an article B stored in the section with the “section ID: 7” and an article C stored in the section with the “section ID: 8” are obstacles for movement of the article A.

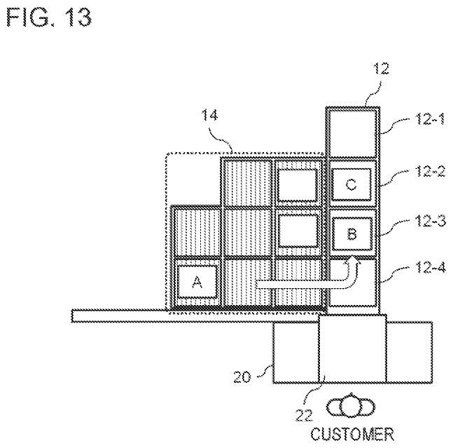

In view of this, as illustrated in FIG. 13, the control apparatus 10 controls the first article transportation path 12 and the second article transportation path 14, and moves the article B and the article C to the relocation space of the first article transportation path 12. In the example in FIG. 13, the article B stored in the section with the “section ID: 7” and the article C stored in the section with the “section ID: 8” are moved to the section 12-3 and the section 12-2 of the first article transportation path 12, respectively. Note that, the control apparatus 10 may move the article B and the article C to the section 12-2 and the section 12-1 of the first article transportation path 12, respectively. As a result of such control, there is no object obstructing the movement of the article A along the route from the section with the “section ID: 6” in which the target article is stored to the customer's window 22, and the article A stored in the section with the “section ID: 6” can be transported to the customer's window 22.

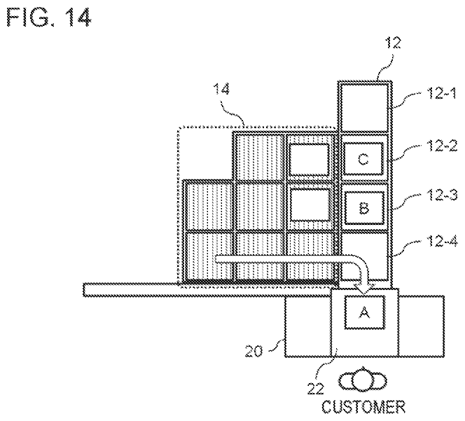

The control apparatus 10 further controls the first article transportation path 12 and the second article transportation path 14, and moves the article A stored in the “section ID: 6” to the customer's window 22 of the automatic article delivery apparatus 20, as illustrated in FIG. 14. As a result, a customer waiting in front of the automatic article delivery apparatus 20 can receive the article A being desired.

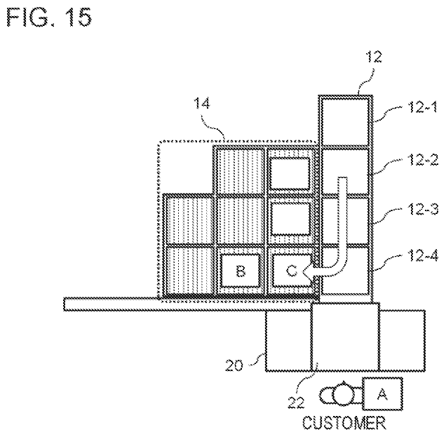

Further, after the article A stored in the “section ID: 6” is moved to the customer's window 22 of the automatic article delivery apparatus 20, the control apparatus 10 further controls the first article transportation path 12 and the second article transportation path 14, and returns the article B and the article C that are temporarily relocated in the relocation space of the first article transportation path 12, to the original storage locations. Specifically, as illustrated in FIG. 15, the control apparatus 10 moves the article B and the article C that are temporarily relocated in the relocation space of the first article transportation path 12, to the section with the “section ID: 7” and the section with the “section ID: 8”, respectively.

In this manner, a desired article is discharged from the automatic article delivery apparatus 20.

Note that, in the examples in FIGS. 12 to 15, description is made on a case in which an available space in the first article transportation path 12 is used, but the control performed for the first article transportation path 12 and the second article transportation path 14 by the control apparatus 10 is not limited to the examples illustrated in those drawings. For example, it is assumed that each of the sections of the second article transportation path 14 includes the mechanism that moves an article in the front-and-rear direction and the mechanism that moves an article in the right-and-left direction. In this case, when at least one section that can be used as a relocation space is present in any one of the first article transportation path 12 and the second article transportation path 14, the control apparatus 10 can move an article from any section to the customer's window 22 in a manner of a sliding puzzle.

### Second Example Embodiment

The present example embodiment includes a configuration similar to that of the first example embodiment, except for the matters described below.

### Function Configuration Example

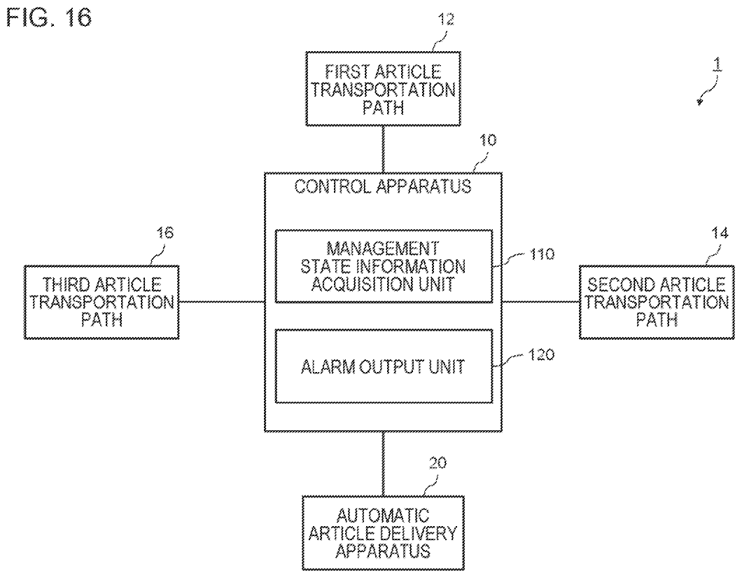

FIG. 16 is a diagram schematically illustrating a function configuration example of an article management system 1 according to a second example embodiment. As illustrated in FIG. 16, the article management system 1 according to the present example embodiment includes a third article transportation path 16 in addition to a first article transportation path 12 and a second article transportation path 14. As illustrated in FIG. 16, in the article management system 1 according to the present example embodiment, a control apparatus 10 is configured to include a management state information acquisition unit 110 and an alarm output unit 120.

Similarly to the first article transportation path 12 and the second article transportation path 14, for example, the third article transportation path 16 is an apparatus that automatically transports an article, for example, such as a belt conveyer and a roller conveyer.

The management state information acquisition unit 110 acquires information (management state information) indicating a state of an article managed in the article management system 1. The management state information is information relating to a state of an article to be delivered to a customer or a state of an article received from a customer. For example, the management state information acquisition unit 110 acquires information relating to a usage state of a storage location of the first article transportation path 12 and a storage location of the second article transportation path 14 or the third article transportation path 16 (example: a section usage rate, a time elapsed from a time when an article is stored in each of the sections), information relating to an attribute (example: low-temperature delivery, frozen delivery) of an article received from a customer, and the like, as the management state information.

The alarm output unit 120 decides whether a management state of an article indicated in the management state information described above satisfies a predetermined alarm output condition. When the management state of the article indicated in the management state information satisfies the predetermined alarm output condition, the alarm output unit 120 outputs an alarm via an apparatus for outputting an alarm. With this, a person involved in a logistics operation in a location provided with the article management system 1 can notice the need to take an action regarding the management state of the article.

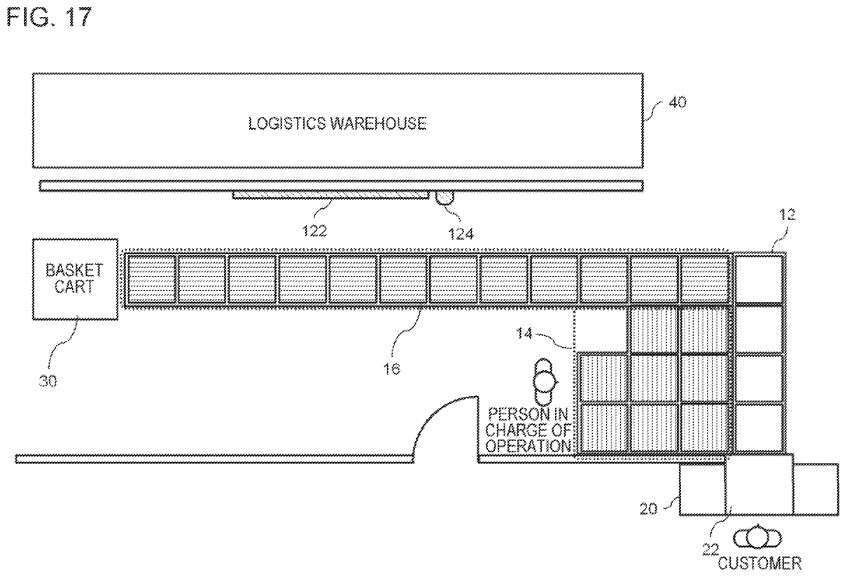

FIG. 17 is a diagram illustrating an arrangement example of the first article transportation path 12, the second article transportation path 14, and the third article transportation path 16 in the article management system 1 according to the second example embodiment. As illustrated in FIG. 17, the article management system 1 according to the present example embodiment includes both the configuration illustrated in FIG. 3 and the configuration illustrated in FIG. 4. Herein, similarly to the article transportation path illustrated in FIG. 4, the second article transportation path 14 according to the present example embodiment is configured to be capable of receiving and delivering an article with the first article transportation path 12, and is used as a storage location for storing an article to be delivered to a customer. Further, similarly to the article transportation path illustrated in FIG. 3, the third article transportation path 16 according to the present example embodiment is configured to be capable of receiving and delivering an article with the first article transportation path 12, and is used as a storage location for storing an article received from a customer. Each of the sections of the third article transportation path 16 includes at least a mechanism for moving an article in a front-and-rear direction (an extension direction of the transportation path). Similarly to the first article transportation path 12, each of the sections of the third article transportation path 16 may further include a mechanism of moving an article in a right-and-left direction (a direction orthogonal to the extension direction of the transportation path) in each of the sections of the transportation path.

Further, the arrangement example illustrated in FIG. 17 includes a basket cart 30 (a collection location for an article) for collecting an article received from a customer by using an automatic article delivery apparatus 20, and a logistics warehouse 40 for storing a collected article. As illustrated, the basket cart 30 and the logistics warehouse 40 are positioned on a side opposite to a location provided with a customer's window 22 (a location for delivering an article to a customer or a location for receiving an article from a customer), with the first article transportation path 12, the second article transportation path 14, and the third article transportation path 16 interposed therebetween. In order to perform efficient operations of collecting and storing an article received from the automatic article delivery apparatus 20, the third article transportation path 16 that transports an article received from the automatic article delivery apparatus 20 is preferably arranged at a position closer to the basket cart 30 and the logistics warehouse 40 than the second article transportation path 14 that transports an article to be delivered to a customer is.

Further, in the arrangement example in FIG. 17, a monitor 122 and an indicating lamp 124 are provided at positions that can be visually recognized by a person in charge of the operation from a workspace. When the predetermined alarm output condition is satisfied, the alarm output unit 120 controls the monitor 122 and the indicating lamp 124, and thus outputs an alarm.

The alarm output unit 120 is capable of outputting, to the monitor 122, a message associated with the alarm output condition being satisfied. In a specific example, a condition that “the predetermined number or more articles are stored in the storage locations of the third article transportation path 16” is set as one of the alarm output conditions, and it is assumed that the alarm output unit 120 decides that the alarm output condition is satisfied, based on the management state information being acquired. In this case, for example, the alarm output unit 120 outputs a message such as “the available storage locations are running low in the third article transportation path 16” or a message such as “the storage locations are full in the third article transportation path 16”. In another example, a condition that “an article left in a storage location of the second article transportation path 14 for a predetermined time or more is present” is set as one of the alarm output conditions, and it is assumed that the alarm output unit 120 decides that the alarm output condition is satisfied, based on the management state information being acquired. In this case, for example, the alarm output unit 120 outputs a message such as “there is an article left in a storage location of the second article transportation path 14”. Further, in another example, a condition that “an article to be delivered in refrigeration or an article to be delivered in freezing is received” is set as an alarm output condition, and it is assumed that the alarm output unit 120 decides that the alarm output condition is satisfied, based on the management state information being acquired. In this case, for example, the alarm output unit 120 outputs a message such as “an article to be delivered in refrigeration/an article to be delivered in freezing is received”.

Further, the alarm output unit 120 may control a lighting state of the indicating lamp 124 to output an alarm, in addition to (or in place of) the message described above. For example, when the indicating lamp 124 associated with each storage location for an article is provided, the alarm output unit 120 is capable of performing control for lighting the indicating lamp 124 associated with a storage location being an alarm target, based on the management state information. Further, the alarm output unit 120 may be configured to output an alarm via a terminal owned by each person in charge of the operation (for example, a smartphone, a tablet terminal, or the like for business).

### Flow of Processing

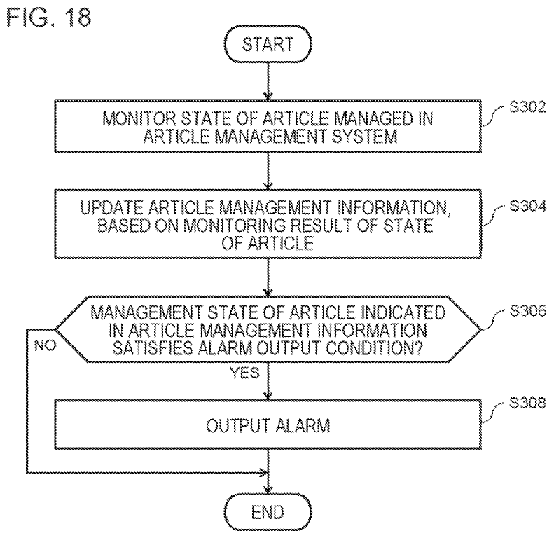

FIG. 18 is a flowchart illustrating a flow of processing performed by the control apparatus 10 according to the second example embodiment.

The management state information acquisition unit 110 monitors a state of an article managed in the article management system 1 (S302). For example, the management state information acquisition unit 110 monitors whether an article is newly received from a customer, or whether a person in charge of the operation newly places, in the second article transportation path 14, an article to be delivered to a customer. The management state information acquisition unit 110 updates article management information, based on a monitoring result of a state of an article (S304). For example, when an article is newly received from a customer, the management state information acquisition unit 110 acquires information such as a storage position of the article (example: a section of the second article transportation path 14 in which the article is stored), a time at which the article is received, and an attribute of the article (example: an article to be delivered in refrigeration/an article to be delivered in freezing). Then, the management state information acquisition unit 110 adds information being acquired with regard to the article, to the article management information stored in a predetermined storage region (a memory 1030, a storage device 1040, or the like).

After that, at any timing, the alarm output unit 120 refers to the article management information being stored in the predetermined storage region, and decides whether the management state of the article being indicated in the article management information satisfies a predetermined alarm condition (S306). When the management state of the article being indicated in the article management information satisfies the predetermined alarm condition (S306: YES), the alarm output unit 120 outputs an alarm via an apparatus for outputting an alarm. The alarm output unit 120 outputs message as exemplified above, on the monitor 122, or controls a lighting state of the indicating lamp 124. When the management state of the article being indicated in the article management information does not satisfy the predetermined alarm condition (S306: NO), the alarm output unit 120 does not output an alarm.

With an alarm from the alarm output unit 120, a person in charge of the operation can notice the need to confirm and improve a state of a managed article, and can take an appropriate action.

While the example embodiments of the present invention are described above with reference to the drawings, the present invention is not limited thereto at the time of interpretation, and various changes, modifications, and the like may be made thereto without departing from the gist of the present invention, based on the knowledge of a person skilled in the art. Further, a plurality of constituent elements disclosed in the example embodiments may be combined with each other as appropriate to form various inventions. For example, some constituent elements may be eliminated from the entire constituent elements indicated in the example embodiments, or the constituent elements of the different example embodiments may be combined with each other as appropriate.

Further, in a plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, each of the example embodiments described above can be combined within a range in which contradiction does not occur in the content.

The whole or a part of the example embodiments described above can be described as, but not limited to, the following supplementary notes.
1.

An article management system for performing at least one of delivery of an article to a customer and receipt of an article from a customer, the article management system including:
a first article transportation path that can be used as a first storage location for storing a plurality of articles, and can deliver or receive an article with a location for delivering an article or receiving an article;
a second article transportation path that can be used as a second storage location for storing a plurality of articles, and can deliver or receive an article with the first article transportation path; and
a control unit that controls the first article transportation path and the second article transportation path.
2.

The article management system according to supplementary note 1, in which
the second article transportation path includes an elevating path, and the second storage location is configured in a three-dimensional manner.
3.

The article management system according to supplementary note 1 or 2, in which
the second article transportation path stores an article to be delivered to the customer.
4.

The article management system according to supplementary note 3, in which
the first article transportation path includes N regions (N is an integer equal to or greater than two) as the first storage location, and
the second article transportation path is configured to allow an article to be placed on any region of the N regions.
5.

The article management system according to supplementary note 4, in which
the second article transportation path is configured by a plurality of conveyers, and
a number of articles that can be stored in each of the plurality of conveyers is decided based on a location of a region of the first article transportation path, the region being connected to each conveyer.
6.

The article management system according to any one of supplementary notes 1 to 5, in which
the article management system is used in a logistics center.
7.

The article management system according to any one of supplementary notes 1 to 6, further including
a third article transportation path that can be used as a third storage location for storing a plurality of articles, and can deliver or receive an article with the first article transportation path, in which
the second article transportation path stores an article to be delivered to a customer, and
the third article transportation path stores an article received from a customer.
8.

The article management system according to supplementary note 7, in which
a logistics warehouse or a collection location are provided on a side opposite to the location for performing delivery of an article or receipt of an article, through the first article transportation path, the second article transportation path, and the third article transportation path, and
the third article transportation path is located on a side closer to the logistics warehouse or the collection location than the second article transportation path is.
9.

The article management system according to supplementary note 7 or 8,further including:
a management state information acquisition unit that acquires management state information indicating a management state of an article to be delivered to a customer or an article received from a customer; and
an alarm output unit that outputs an alarm when the management state of an article being indicated in the management state information satisfies a predetermine alarm output condition.
10.

An article management method including,
by a computer, managing an article by controlling
a first article transportation path that can be used as a first storage location for storing a plurality of articles, and can deliver or receive an article with a location for delivering an article or receiving an article, and
a second article transportation path that can be used as a second storage location for storing a plurality of articles, and can deliver or receive an article with the first article transportation path.
11.

The article management method according to supplementary note 10, in which
the second article transportation path includes an elevating path, and the second storage location is configured in a three-dimensional manner.
12.

The article management method according to supplementary note 10 or 11, in which
the second article transportation path stores an article to be delivered to the customer.
13.

The article management method according to supplementary note 12, in which
the first article transportation path includes N regions (N is an integer equal to or greater than two) as the first storage location, and
the second article transportation path is configured to allow an article to be placed on any region of the N regions.
14.

The article management method according to supplementary note 13, in which
the second article transportation path is configured by a plurality of conveyers, and
a number of articles that can be stored in each of the plurality of conveyers is decided based on a location of a region of the first article transportation path, the region being connected to each conveyer.
15.

The article management method according to any one of supplementary notes 10 to 14, in which
the article management method is used in a logistics center.
16.

The article management method according to any one of supplementary notes 10 to 15, further including
a third article transportation path that can be used as a third storage location for storing a plurality of articles, and can deliver or receive an article with the first article transportation path, in which
the second article transportation path stores an article to be delivered to a customer, and
the third article transportation path stores an article received from a customer.
17.

The article management method according to supplementary note 16, in which
a logistics warehouse or a collection location are provided on a side opposite to the location for performing delivery of an article or receipt of an article, through the first article transportation path, the second article transportation path, and the third article transportation path, and
the third article transportation path is located on a side closer to the logistics warehouse or the collection location than the second article transportation path is.
18.

The article management method according to supplementary note 16 or 17, further including,
by a computer:
acquiring management state information indicating a management state of an article to be delivered to a customer or an article received from a customer; and
outputting an alarm when the management state of an article being indicated in the management state information satisfies a predetermine alarm output condition.
19.

A program causing a computer to function as:
a control unit that controls a first article transportation path that can be used as a first storage location for storing a plurality of articles and can deliver or receive an article with a location for delivering an article or receiving an article, and a second article transportation path that can be used as a second storage location for storing a plurality of articles and can deliver or receive an article with the first article transportation path.
20.

The program according to supplementary note 19, in which
the second article transportation path includes an elevating path, and the second storage location is configured in a three-dimensional manner.
21.

The program according to supplementary note 19 or 20, in which
the second article transportation path stores an article to be delivered to the customer.
22.

The program according to supplementary note 21, in which
the first article transportation path includes N regions (N is an integer equal to or greater than two) as the first storage location, and
the second article transportation path is configured to allow an article to be placed on any region of the N regions.
23.

The program according to supplementary note 22, in which
the second article transportation path is configured by a plurality of conveyers, and
a number of articles that can be stored in each of the plurality of conveyers is decided based on a location of a region of the first article transportation path, the region being connected to each conveyer.
24.

The program according to any one of supplementary notes 19 to 23, in which
the program is used in a logistics center.
25.

The program according to any one of supplementary notes 19 to 24, further including
a third article transportation path that can be used as a third storage location for storing a plurality of articles, and can deliver or receive an article with the first article transportation path, in which
the second article transportation path stores an article to be delivered to a customer, and
the third article transportation path stores an article received from a customer.
26.

The program according to supplementary note 25, in which
a logistics warehouse or a collection location are provided on a side opposite to the location for performing delivery of an article or receipt of an article, through the first article transportation path, the second article transportation path, and the third article transportation path, and
the third article transportation path is located on a side closer to the logistics warehouse or the collection location than the second article transportation path is.
27.

The program according to supplementary note 25 or 26, further causing the computer to function as:
a management state information acquisition unit that acquires management state information indicating a management state of an article to be delivered to a customer or an article received from a customer; and
an alarm output unit that outputs an alarm when the management state of an article being indicated in the management state information satisfies a predetermine alarm output condition.

### REFERENCE SIGNS LIST

1 Article management system
10 Control apparatus
1010 Bus
1020 Processor
1030 Memory
1040 Storage device
1050 Input/output interface
1060 Network interface
110 Management state information acquisition unit
120 Alarm output unit
122 Monitor
124 Indicating lamp
12 First article transportation path
14 Second article transportation path
16 Third article transportation path
20 Automatic article delivery apparatus
22 Customer's window
30 Basket cart
40 Logistics warehouse

What is claimed is:

1. An article management system for performing at least one of delivery of an article to a customer and receipt of an article from a customer, the article management system comprising:
a first article transportation path that can be used as a first storage location for storing a plurality of articles, and can deliver or receive an article with a location for delivering an article or receiving an article;
a second article transportation path that can be used as a second storage location for storing a plurality of articles, and can deliver or receive an article with the first article transportation path; and
at least one memory configured to store instructions; and
at least one processor configured to execute the instructions to perform operations comprising
controlling the first article transportation path and the second article transportation path.

2. The article management system according to claim 1, wherein
the second article transportation path includes an elevating path, and the second storage location is configured in a three-dimensional manner.

3. The article management system according to claim 1, wherein
the second article transportation path stores an article to be delivered to the customer.

4. The article management system according to claim 3, wherein
the first article transportation path includes N regions (N is an integer equal to or greater than two) as the first storage location, and
the second article transportation path is configured to allow an article to be placed on any region of the N regions

5. The article management system according to claim 4, wherein
the second article transportation path is configured by a plurality of conveyers, and
a number of articles that can be stored in each of the plurality of conveyers is decided based on a location of a region of the first article transportation path, the region being connected to each conveyer.

6. The article management system according to claim 1, wherein
the article management system is used in a logistics center.

7. The article management system according to claim 1, further comprising
a third article transportation path that can be used as a third storage location for storing a plurality of articles, and can deliver or receive an article with the first article transportation path, wherein
the second article transportation path stores an article to be delivered to a customer, and
the third article transportation path stores an article received from a customer.

8. The article management system according to claim 7, wherein
a logistics warehouse or a collection location are provided on a side opposite to the location for performing delivery of an article or receipt of an article, through the first article transportation path, the second article transportation path, and the third article transportation path, and
the third article transportation path is located on a side closer to the logistics warehouse or the collection location than the second article transportation path is.

9. The article management system according to claim 7, wherein the operations further comprise:
acquiring management state information indicating a management state of an article to be delivered to a customer or an article received from a customer; and
outputting an alarm when the management state of an article being indicated in the management state information satisfies a predetermine alarm output condition.

10. An article management method comprising,
by a computer, managing an article by controlling
a first article transportation path that can be used as a first storage location for storing a plurality of articles, and can deliver or receive an article with a location for delivering an article or receiving an article, and
a second article transportation path that can be used as a second storage location for storing a plurality of articles, and can deliver or receive an article with the first article transportation path.

11. The article management method according to claim 10, wherein
the second article transportation path includes an elevating path, and the second storage location is configured in a three-dimensional manner.

12. The article management method according to claim 10, wherein
the second article transportation path stores an article to be delivered to the customer.

13. The article management method according to claim 12, wherein
the first article transportation path includes N regions (N is an integer equal to or greater than two) as the first storage location, and
the second article transportation path is configured to allow an article to be placed on any region of the N regions

14. The article management method according to claim 13, wherein
the second article transportation path is configured by a plurality of conveyers, and
a number of articles that can be stored in each of the plurality of conveyers is decided based on a location of a region of the first article transportation path, the region being connected to each conveyer.

15. The article management method according to claim 10, wherein
the computer is used in a logistics center.

16. The article management method according to claim 10, further comprising
a third article transportation path that can be used as a third storage location for storing a plurality of articles, and can deliver or receive an article with the first article transportation path, wherein
the second article transportation path stores an article to be delivered to a customer, and
the third article transportation path stores an article received from a customer.

17. The article management method according to claim 16, wherein
a logistics warehouse or a collection location are provided on a side opposite to the location for performing delivery of an article or receipt of an article, through the first article transportation path, the second article transportation path, and the third article transportation path, and
the third article transportation path is located on a side closer to the logistics warehouse or the collection location than the second article transportation path is.

18. The article management method according to claim 16, wherein the method further comprises:
by the computer,
acquiring management state information indicating a management state of an article to be delivered to a customer or an article received from a customer; and
outputting an alarm when the management state of an article being indicated in the management state information satisfies a predetermine alarm output condition.

19. A non-transitory computer-readable medium storing a program for causing a computer to perform operations comprising
controlling a first article transportation path that can be used as a first storage location for storing a plurality of articles and can deliver or receive an article with a location for delivering an article or receiving an article, and a second article transportation path that can be used as a second storage location for storing a plurality of articles and can deliver or receive an article with the first article transportation path.
